(19) United States
(12) Patent Application Publication
(10) Pub. No.: US 2003/0210232 A1
(43) Pub. Date: Nov. 13, 2003

(54) Multimedia keyboard

(76) Inventor: Peter Chen, Taipei (TW)

Correspondence Address: RABIN & BERDO, P.C., Suite 500, 1101 14th Street, N.W., Washington, DC, 20005, US

(21) Appl. No.: 10/142,892

(22) Filed: May 13, 2002

(51) Int. Cl. G09G 5/00

(52) U.S. Cl. 345/168

(57) ABSTRACT

A multimedia keyboard includes a general text key zone and a special function key zone. The latter is further divided into eight major function zones, including a function key converting zone, connected to I/O ports of a microprocessor included in an internal circuit configuration of the keyboard. The keyboard uses a seventh class code that defines E2 as a leading code and an intercept scan code program to enable use of keys in the function key converting zone to select whether to decode the leading code E2 or not, so that a connected computer may determine whether a keyboard code is a conventional or a non-conventional identification part. Whereby the keyboard provides shortcut key functions without the need of any special driver, and may be expanded to provide new function keys when the computer selects to identify the non-conventional identification part.

### BACKGROUND OF THE INVENTION

The present invention relates to a keyboard with special keys, and more particularly to a multimedia keyboard that uses a seventh class code defining E2 as a leading code and an intercept scan code program to enable use of keys in a function key converting zone to select whether to decode the leading code E2 or not, so that a connected computer may determine whether a keyboard code is a conventional or a non-conventional identification part. With these arrangements, the keyboard provides shortcut key functions without the need of any special driver, and may be expanded to provide new function keys when the computer selects to identify the non-conventional identification part, enabling a user to actively use and set different functions on the keyboard.

With the constantly developed computer-related technologies and applications, new and improved information industrial products are continuously introduced into the markets. However, there is not any significant improvement made to the conventional keyboard (see FIG. 1) for input through manual operation. While powerful functions and easy operation are two major requirements of nowadays apparatus and equipment, most currently available operating systems and document editing programs must be operated and executed via a mouse, with which a user selects a desired function from a menu. The user has to move his or her body to complete input of instructions. This type of operating manner is, of course, laborious and inconvenient for users and tends to cause injured arms and wrists when the users keep using computers in this manner for a prolonged time.

A multimedia keyboard as shown in FIG. 2 has been developed and introduced into the market in an attempt to relieve computer users from the above-mentioned laborious and inconvenient operating manner. This type of multimedia keyboard is formed by incorporating many hot keys providing special functions into a conventional standard keyboard and is driven with specified keyboard driver. A user working under Windows needs only to press these special functional keys to execute corresponding instructions. However, the mouse is still a necessary aid and the user has to move his or her hands and wrists as frequently as before. Therefore, the conventional multimedia keyboard is not so helpful as it is expected to be.

With a conventional hot key driver using known skills, a hot key is provided by sending from the keyboard an “E0 XX” or a usage code, and putting a path of a file and an application filename argument in the function WinExec O provided by Windows API. Thus, the hot key is only workable for controlling or calling a program but not internal particular instructions of the program. Besides, the use of hot keys occupies a large quantity of software resources under Windows.

FIG. 3 shows a Windows keyboard developed by some professional keyboard manufacturers. Keys on this type of keyboard are divided into four zones, namely, general text key zone, document editing modular key zone, office application modular key zone, and application programming modular key zone. On this type of Windows keyboard, codes of combinations of multiple keys are used to provide acceleration key functions. Such functions are “dead” and are not easily changed with drivers, they could only be executed within a few number of programs. The use of combinations of multiple keys would even cause unpredictable results in some programs.

It is therefore tried by the inventor to develop a multimedia keyboard that uses a seventh class code defining E2 as a leading code and an intercept scan code program to enable use of keys in a function key converting zone to select whether to decode the leading code E2 or not, so that a connected computer may determine whether a key code is a conventional or a non-conventional identification part. With these arrangements, the keyboard provides shortcut key functions without the need of any special driver, and may be expanded to provide new function keys when the computer selects to identify the non-conventional identification part, enabling a user to actively use and set different functions on the keyboard.

### SUMMARY OF THE INVENTION

A primary object of the present invention is to provide a multimedia keyboard that provides shortcut key functions without the need of any specific driver and may be expanded to provide new function keys when a connected computer selects to identify the non-conventional identification part, enabling a user to actively use and set different functions on the keyboard.

To achieve the above and other objects, the multimedia keyboard of the present invention mainly includes a general text key zone and a special function key zone. The special function key zone is further divided into eight major function zones, namely, Internet zone, multimedia play zone, application zone, function key converting zone, mouse editing zone, power management zone, indicator zone, and numeric zone. These major function zones are connected to I/O ports of a microprocessor included in an internal circuit configuration of the multimedia keyboard. The multimedia keyboard uses a seventh class code that defines E2 as a leading code and an intercept scan code program to enable use of keys in the function key converting zone to select whether to decode the leading code E2 or not, so that a computer to which said multimedia keyboard is connected may determine whether a keyboard code is a conventional or a non-conventional identification part. With these arrangements, the multimedia keyboard may provide shortcut key functions without the need of any special driver, and may be expanded to provide new function keys when the computer selects to identify said non-conventional identification part, enabling a user to actively use and set different functions on said keyboard.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional standard keyboard;

FIG. 2 shows a conventional multimedia keyboard;

FIG. 3 shows a conventional Windows keyboard;

FIG. 4 shows a multimedia keyboard according to a preferred embodiment of the present invention;

FIG. 5 is a circuit diagram showing an internal circuit of the multimedia keyboard of the present invention; and

FIG. 6 is a representative matrix of keys that are shown on the multimedia keyboard of the present invention.

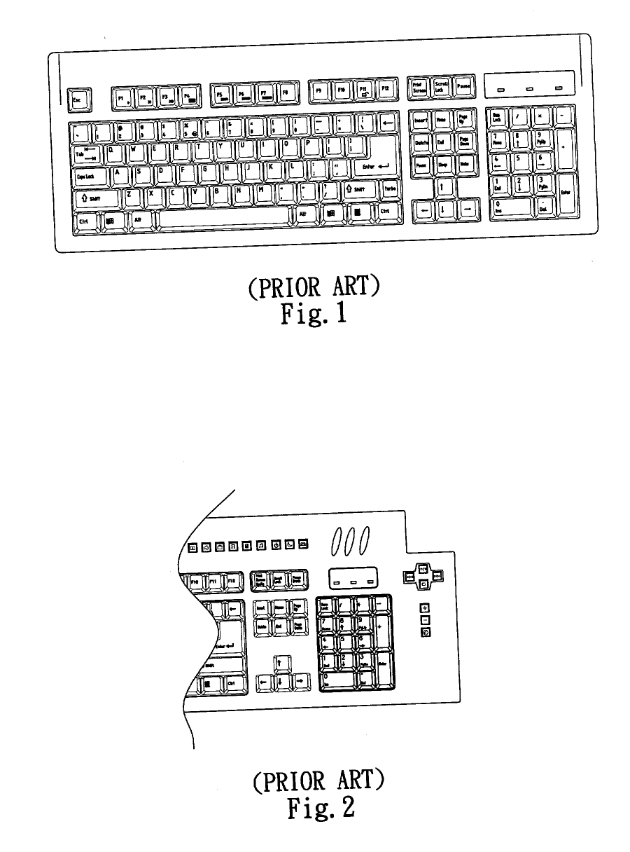

### DETAILED DESCRIPTION OF THE PREFERRED EMBODIMENTS

The keyboard of the present invention defines an E2 leading code, such as E2XXE2F0XX, which is sent out from the keyboard itself and uses a completed kernel program located at a base layer of the operating system to serve as a shortcut key processing function module that must include a usage key code of intercepting and converting program in the form of terminate and stay resident (TSR). For example, when a user works under Windows, he or she would have to press and hold Alt and E and then press R to perform the redo function. However, with the keyboard of the present invention that uses E2 as a leading code, the user needs only to press one single key to perform the redo function. The following Table 1 shows different key combinations for different functions under Windows.

TABLE 1

| Function | Key Combinations |
|---|---|
| Redo | ALT+E, R; or ALT+ENTER; or |
| | ALT+SHIFT+BACKSPACE |
| Undo | ALT+E, U; or ALT+BACKSPACE |
| Open | ALT+F, O; or CTRL+O; or CTRL+F12; |
| | or ALT+CTRL+F2 |
| New | ALT+F, N; or CTRL+N |
| Bold | CTRL+B; or CTRL+SHIFT+B |
| Save | ALT+F, S; or CTRL+S; or SHIFT+F12; |
| | or ALT+SHIFT+F2 |
| Take pane | ALT+E, K |
| Fwd | CTRL+F |
| Reply | CTRL+R |
| Send | ALT+; or CTRL+ENTER |
| Bullets and | ALT+O, N |
| Number | |
| Replace | ALT+E, E |
| Application | ALT+SHIFT+TAB; or ALT+TAB |
| switch | |
| Close | ALT+F4; or CTRL+W |
| application | |
| Log off | WIN, L |
| Cut | ALT+E, T; or CTRL+X; or SHIFT +DEL |
| Paste | ALT+E, P; or CTRL+V; or SHIFT |
| | +INSERT |
| Copy | ALT+E, C; or CTRL+C; or CTRL |
| | +INSERT |
| Mark | SHIFT MARK |

And, for example, when performing Chinese/English keyin under MS-DOS, a user would have to press and hold Ctrl while press the Space bar to toggle between Chinese and English. However, with the keyboard of the present invention, when a key of E2XXE2F0XX is designated and the usage key code of intercepting and converting program is running, the user can quickly complete the toggle with only one single finger. Or, when working under X Window (i.e. Linux), a usage key may also use a completed kernel program located at a base layer of the operating system to serve as a shortcut key processing function module that must include a usage key code of intercepting and converting program in the form of terminate and stay resident (TSR). For example, the user may press a key of E2XXE2F0XX to emulate Ctrl +Alt +F1 and switch a terminal. Or, when working under Windows, a user may use function SHELLEXEC( ) to call and execute other external programs. For example, pressing of an E-mail key will send out a code of E201E2F001. When the TSR receives the code, it immediately converts the code and uses the function SHELLEXEC( ) to call “C:\PROGRAM FILES\OUTLOOK EXPRESS\MSIMN.EXE”. At this point, the user can send E-mail.

The keyboard of the present invention enables different kinds of inputs, so that a user may perform professional and convenient operation or document editing directly over a computer operating system without the need of memorizing and combining multiple keys or using a mouse as an aid.

The multimedia keyboard of the present invention uses a shortcut key scan code that includes E2 as a leading code and codes of standard keys following the leading code E2. The following Table 2 shows some shortcut key scan codes used by the keyboard of the present invention.

TABLE 2

| | SET1 | | | | | | SET2 | | | | | | |
|---|---|---|---|---|---|---|---|---|---|---|---|---|---|
| | MAKE | | | BREAK | | | MAKE | | | BREAK | | | |
| Function | CODE | | | CODE | | | CODE | | | CODE | | | |
| (WWW) Back | E2 | E0 | 6A | E2 | E0 | EA | E2 | E0 | 38 | E2 | E0 | F0 | 38 |
| (WWW) Forward | E2 | E0 | 69 | E2 | E0 | E9 | E2 | E0 | 30 | E2 | E0 | F0 | 30 |
| (WWW) Stop | E2 | E0 | 68 | E2 | E0 | E9 | E2 | E0 | 28 | E2 | E0 | F0 | 28 |
| (WWW) Refresh | E2 | E0 | 67 | E2 | E0 | E7 | E2 | E0 | 20 | E2 | E0 | F0 | 20 |
| (WWW) Search | E2 | E0 | 65 | E2 | E0 | E5 | E2 | E0 | 10 | E2 | E0 | F0 | 10 |
| (WWW) Favorites | E2 | E0 | 66 | E2 | E0 | E6 | E2 | E0 | 18 | E2 | E0 | F0 | 18 |
| (WWW) Home | E2 | E0 | 32 | E2 | E0 | B2 | E2 | E0 | 3A | E2 | E0 | F0 | 3A |
| Mail | E2 | E0 | 6C | E2 | E0 | EC | E2 | E0 | 48 | E2 | E0 | F0 | 48 |
| Mute | E2 | E0 | 20 | E2 | E0 | A0 | E2 | E0 | 23 | E2 | E0 | F0 | 23 |
| Volume− | E2 | E0 | 2E | E2 | E0 | AE | E2 | E0 | 21 | E2 | E0 | F0 | 21 |
| Volume+ | E2 | E0 | 30 | E2 | E0 | B0 | E2 | E0 | 32 | E2 | E0 | F0 | 32 |
| Previous | E2 | E0 | 10 | E2 | E0 | 90 | E2 | E0 | 15 | E2 | E0 | F0 | 15 |
| Stop | E2 | E0 | 24 | E2 | E0 | A4 | E2 | E0 | 3B | E2 | E0 | F0 | 3B |
| Play | E2 | E0 | 22 | E2 | E0 | A2 | E2 | E0 | 34 | E2 | E0 | F0 | 34 |
| Next | E2 | E0 | 19 | E2 | E0 | 99 | E2 | E0 | 4D | E2 | E0 | F0 | 4D |
| Media | E2 | E0 | 6D | E2 | E0 | ED | E2 | E0 | 50 | E2 | E0 | F0 | 50 |
| Calculator | E2 | E0 | 21 | E2 | E0 | A1 | E2 | E0 | 2B | E2 | E0 | F0 | 2B |
| My Computer | E2 | E0 | 6B | E2 | E0 | EB | E2 | E0 | 40 | E2 | E0 | F0 | 40 |

Moreover, with the keyboard of the present invention, multiple key codes may be added to the E2 leading code to form new key scan codes. The following Table 3 shows some of the new key scan codes used in the keyboard 10 of the present invention.

TABLE 3

| | Leading | |
|---|---|---|
| Function | Code | Key Combinations |
| Redo | E2 | ALT+E, R; or ALT+ENTER; or |
| | | ALT+SHIFT+BACKSPACE |
| Undo | E2 | ALT+E, U; or ALT+BACKSPACE |
| Open | E2 | ALT+F, O; or CTRL+O; or CTRL+F12; |
| | | or ALT+CTRL+F2 |
| New | E2 | ALT+F, N; or CTRL+N |
| Bold | E2 | CTRL+B; or CTRL+SHIFT+B |
| Save | E2 | ALT+F, S; or CTRL+S; or |
| | | SHIFT+F12; or ALT+SHIFT+F2 |
| Take pane | E2 | ALT+E, K |
| Find Word | E2 | CTRL+F |
| Reply | E2 | CTRL+R |
| Send | E2 | ALT+; or CTRL+ENTER |
| Bullets and | E2 | ALT+O, N |
| Number | | |
| Replace | E2 | ALT+E, E |
| Application | E2 | ALT+SHIFT+TAB; or ALT+TAB |
| switch | | |
| Close | E2 | ALT+F4; or CTRL+W |
| application | | |
| Log off | E2 | WIN, L |
| Cut | E2 | ALT+E, T; or CTRL+X; or SHIFT +DEL |
| Paste | E2 | ALT+E, P; or CTRL+V; or SHIFT |
| | | +INSERT |
| Copy | E2 | ALT+E, C; or CTRL+C; or CTRL |
| | | +INSERT |
| Mark | E2 | SHIFT MARK |

It can be found from Table 2 that whole key scan codes may be divided into a conventional identification part and a non-conventional identification part using the E2 leading code. The conventional identification part is a code that can be automatically identified by a computer without the need of any special driver. On the other hand, the non-conventional identification part requires a special intercept code scan program, or the computer would ignore this part of the key scan code.

Thus, the keyboard of the present invention can provide the shortcut key functions without the need of any special driver and such functions can be easily modified. More particularly, in the present invention, a key code using E2 as a leading code is treated as one single code and a conventional application coding is utilized. That is, the keyboard of the present invention sends out “E2 XX . . . XX” or a usage code, and uses a login databank of Windows to preset functions, and puts a path of a file and an application filename argument in the function SHELLEXCUT ( ) or CREATEPROCESS provided by Windows API, so that control key combinations provided by the present invention may provide quick word editing function, multimedia function, or other control functions.

Therefore, the present invention is much superior to the conventional keyboard, multimedia keyboard or Windows keyboard that provide only “dead functions”. Moreover, the keyboard of the present invention can be effectively expanded to include other functions needed by users.

It can be seen from Table 3 that, on the keyboard of the present invention, the CUT key has a key scan code that may include the leading code E2 and key combinations of ALT+E, T; CTRL+X; or the leading code E2 and the key combinations of SHIFT+DEL; the PASTE key has a key scan code that may include the leading code E2 and key combinations of CTRL+V; SHIFT+INSERT; or the leading code E2 and the key combinations of ALT+E, P (it means to press and hold ALT, and then press E, and then release ALT and E at the same time, and then press P, and then release P); and the COPY key has a key scan code that may include the leading code E2 and key combinations of ALT+E, C; CTRL+C; or the leading code E2 and the key combinations of CTRL+INSERT. This design is completely different from that to other currently commercially available keyboards using known skills. Since run speed varies from computer to computer, and shortcut keys on the keyboard of the present invention emulate the press, the release, and the re-press of keys, it is impossible for a keyboard controller of the keyboard of the present invention to detect a depressed shortcut key and send out key combinations at a speed the same as that of a general keyboard. In a preferred embodiment of the present invention, two continuous key codes for a shortcut key must be spaced by at least 3.2 ms, or a few types of computers would miss the key codes and fail to execute the intended functions.

The following takes the key Redo as an example to describe how the keyboard of the present invention works.

As shown in Table 3, the redo key has a key scan code including E2 followed by ALT+E, R. When in SET1, the complete scan code for the key Redo is E2 38 12 B8 92 13 93 E2 or E2 38 12 B8 92 13 93. In a case where the intercept scan code program is not installed, the operating system would ignore all E2 codes and decodes only the portion of 38 12 B8 92 13 93. At this point, the system would call editing of pull-down menu and immediately decode the key scan code, and then call the option of Redo, so as to provide the shortcut key function.

In the case a user does not like this function, he or she may select another function in which an intercept scan code program is used to intercept the entire code E2 38 12 B8 92 13 93 E2 or E2 38 12 B8 92 13 93, and put a path of a file and an application filename argument in the function SHELLEXCUT ( ) or CREATEPROCESS.

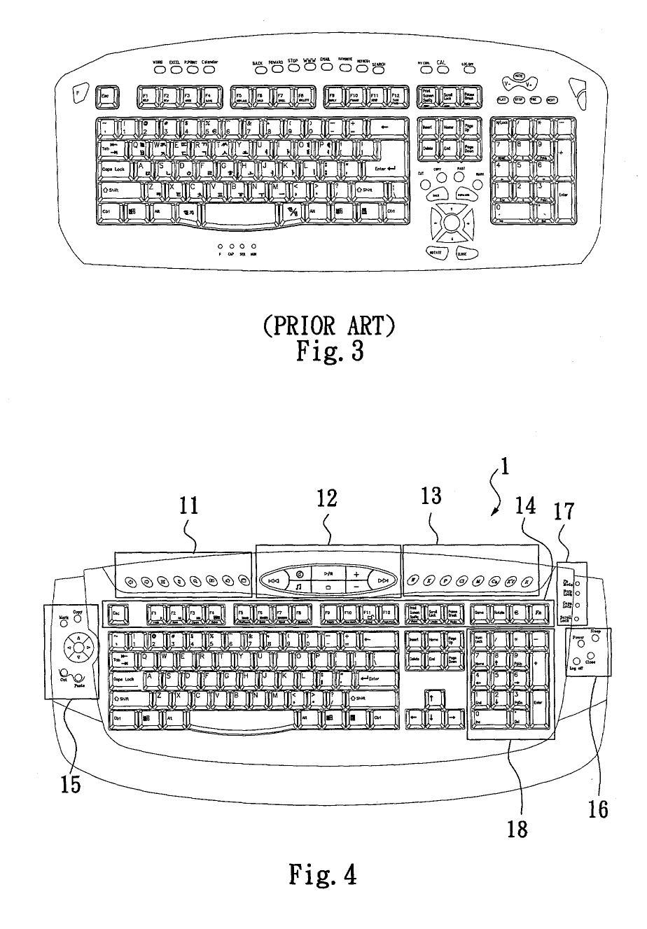

FIG. 4 shows a multimedia keyboard 1 according to a preferred embodiment of the present invention. As shown, the keyboard is divided into two zones, namely, general text key zone and special function key zone. The special function key zone is further divided into eight major function zones, namely, Internet zone 11, multimedia play zone 12, application zone 13, function key converting zone 14, mouse editing zone 15, power management zone 16, indicator zone 17, and numeric zone 18. These zones are connected to I/O ports of a microprocessor included in an internal circuit configuration of the keyboard, so that a user may directly use these modular keys. With a seventh class code that defines E2 as a leading code and an intercept scan code program, the user may use keys in the function key converting zone 14 to select whether to decode the leading code E2 or not, so that a computer to which the keyboard is connected may determine whether the keyboard code is a conventional or a non-conventional identification part. With these arrangements, the multimedia keyboard 1 may provide the shortcut key function without the need of any special driver. Moreover, when the computer selects to identify the non-conventional identification part, the keyboard 1 is expanded to provide new function keys, enabling the user to actively use and set different functions on the keyboard 1. The modular keys included in the above-mentioned eight function zones may be independently or simultaneously provided on the keyboard, and their functions maybe performed via other standard keys or independent keys. A toggle key may be used to control these modular keys without support from other drivers. A light-emitting element may be used to indicate the state of toggle.

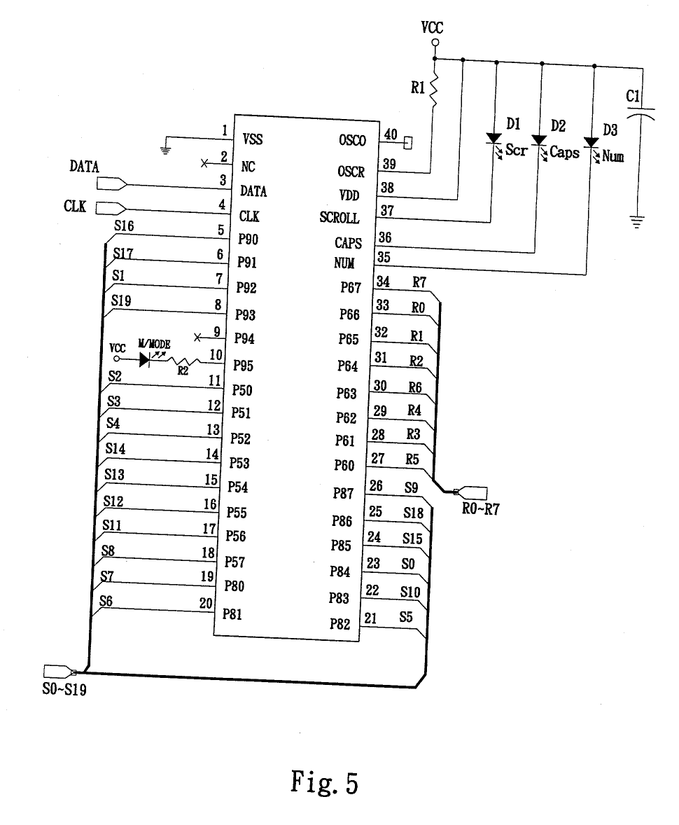

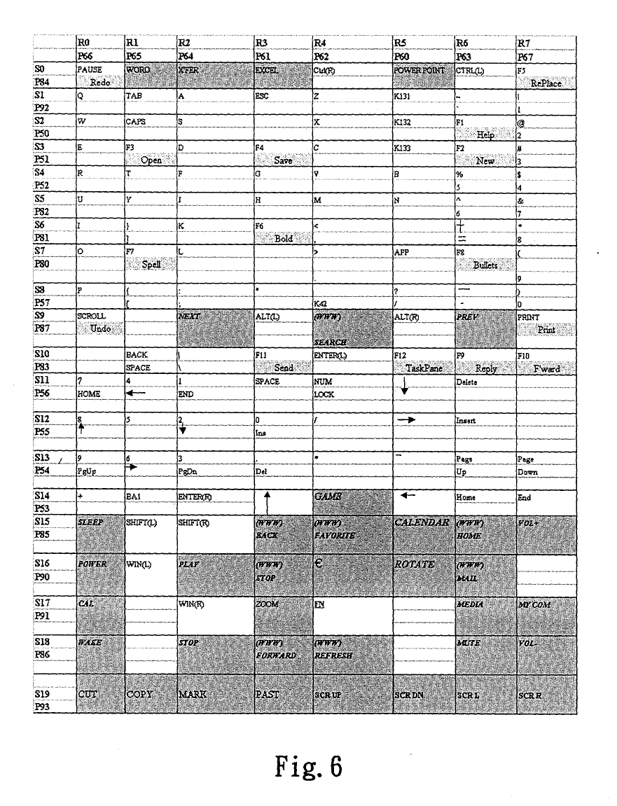

As mentioned before, the multimedia keyboard of the present invention may select to perform the standard functions or use an intercept scan code program to perform the particularly set functions. To enable the keyboard 1 to do so, the keyboard 1 is provided in the function key converting zone 14 with a parent commander key FN. Please refer to FIG. 5 that is an internal circuit diagram of the keyboard of the present invention, and to FIG. 6 that is a representative matrix of keys of the keyboard of the present invention. The key FN corresponds to S17, P91/R4, P62 on the representative matrix of keys of FIG. 6. The key FN may work with other child toggle keys to toggle between different functions.

The child toggle keys may be incorporated into the original function keys. For example, ESC key corresponding to S1/R3, P61 represents a child function key A, and F1 corresponding to S2/R6, P63 represents a child function key B. When the parent commander key FN is pressed and held and the child function key A is then pressed, and the child function key A and the parent commander key FN are sequentially released later, the keyboard controller would send out an identifier E2 E0 00 to the operating system and simultaneously convert the way in which it sends the key scan code. That is, the keys F1, F2, . . . , F12, Print Screen, Scroll Lock, Pause, etc. are converted from the original standard function keys into shortcut keys using a leading code E2. At this point, an Fn Mode indicator provided in the indicator zone 17 lights, but the computer does not display on the screen the indicated state. The user may easily know that the keys F1, F2, . . . , F12, Print Screen, Scroll Lock, Pause, etc. currently provide the shortcut functions set at the time the keyboard is manufactured. When the parent commander key Fn is pressed and held and the child function key A is then pressed, and the child function key A and the parent commander key FN are sequentially released later, the keyboard controller would send out the identifier E2 E0 00 again to the operating system and simultaneously convert the way in which it sends the key scan code. That is, the functions of the shortcut keys using leading code E2 are returned to the standard functions of the keys F1, F2, . . . , F12, Print Screen, Scroll Lock, Pause, etc.

When the parent commander key Fn is pressed and held, and the child function key B is then pressed, and the child function key B and the parent commander key FN are sequentially released later, the keyboard controller would send out an identifier code E2 E0 01 to the operating system and simultaneously convert the way in which it sends the key scan code. That is, the keys F1, F2, . . . , F12, Print Screen, Scroll Lock, Pause, etc. are converted from the original standard function keys into shortcut keys using a leading code E2. At this point, the Fn Mode indicator provided in the indicator zone 17 lights, and the computer displays on the screen the indicated state, so that the installed drivers function to decode all the key scan codes having the leading code E2, enabling the user to easily know that the keys F1, F2, . . . , F12, Print Screen, Scroll Lock, Pause, etc. currently provide the use-defined functions. When the parent commander key Fn is pressed and held again and the child function key B is then pressed, and the child function key B and the parent commander key FN are sequentially released later, the keyboard controller would send out the identifier E2 E0 01 again to the operating system and simultaneously convert the way in which it sends the key scan code. That is, the functions of the shortcut keys using leading code E2 are returned to the standard functions of the keys F1, F2, . . . , F12, Print Screen, Scroll Lock, Pause, etc.

The child function keys A and B may be alternately set for use. That is, different f unctions may be directly set on the user's keyboard via the parent commander key and the child function key A, and the functions may be set on the shortcut function keys pre-provided on the manufacturer's keyboard.

The following are some advantages of the keyboard of the present invention:

1. The user may directly use modular keys to edit documents or control computer instructions without the need of memorizing key combinations or using a mouse as an aid.

2. The keyboard works independently without the support from any keyboard driver. The problem of software compatibility is eliminated to meet all users' satisfaction.

3. The user is allowed to open any program via setting the shortcut function. The keyboard is therefore very convenient for use.

4. With E2 as the leading code, the keyboard uses the login databank of Windows to preset functions, and puts a path of a file and an application filename argument in the function SHELLEXCUT ( ) or CREATEPROCESS provided by Windows API, so that control key combinations may provide quick word editing function, multimedia function, or other control functions.

From the above description, it can be seen the keyboard of the present invention not only uses leading code E2 and corresponding key combinations to achieve intended functions, but is compatible with other earlier office software, such as Windows, Office, Works, Corel draw, and Photo impact. The keyboard of the present invention needs not to install other programs to execute acceleration key functions needed in text editing. The user is enabled to quickly run Word, Excel, Power Point, Outlook, calculator, Game, etc. under the shortcut functions provided by the operating system while occupying only very little Windows resource. With the keyboard of the present invention, the shortcut keys may be expanded in response to actual needs and to fully extend their intended functions.

The present invention has been described with a preferred embodiment thereof and it is understood that many changes and modifications in the described embodiment can be carried out without departing from the scope and the spirit of the invention as defined by the appended claims. For example, the function keys in the modular keys may be incorporated into the keyboard according to actual need, and the function keys formed by the leading code E2 followed by corresponding key combinations may also be used along with SHIFT, CTRL, or ALT, or be pressed, released, or pressed again to provide other functions.

What is claimed is:

1. A multimedia keyboard, comprising a general text key zone and a special function key zone, said special function key zone being further divided into eight major function zones, namely, Internet zone, multimedia play zone, application zone, function key converting zone, mouse editing zone, power management zone, indicator zone, and numeric zone; and said eight major function zones being connected to I/O ports of a microcomputer included in an internal circuit configuration of said multimedia keyboard; said multimedia keyboard using a seventh class code that defines E2 as a leading code and an intercept scan code program to enable use of keys in said function key converting zone to select whether to decode the leading code E2 or not, so that a computer to which said multimedia keyboard is connected may determine whether a keyboard code is a conventional or a non-conventional identification part; whereby said multimedia keyboard may provide shortcut key functions without the need of any special driver, and may be expanded to provide new function keys when the computer selects to identify said non-conventional identification part, enabling a user to actively use and set different functions on said keyboard.

2. The multimedia keyboard as claimed in claim 1, wherein said function key converting zone includes a parent commander key FN and a plurality of child function keys, including F1, F2, . . . , F12, Print Screen, Scroll Lock, Pause, etc.
